(19) United States
(12) Patent Application Publication
(10) Pub. No.: US 2009/0223506 A1
(43) Pub. Date: Sep. 10, 2009

(54) Crateless retorting with improved cold water infestation prevention for eliminating under processing in the canned foods industry (botulism prevention)

(76) Inventor: Lawrence Kirk Baumann, Evans, GA (US)

Correspondence Address: L. KIRK BAUMANN, 937 NAPIERS POST DR, EVANS, GA, 30809, US

(21) Appl. No.: 12/074,817

(22) Filed: Mar. 7, 2008

(51) Int. Cl. A23L 3/10

(52) U.S. Cl. 126/369; 426/401; 126/348

(57) ABSTRACT

The technical simplification of the invention is on FIG. 5. That is X<Y<Z. This simple expression represents the elevation of the three nozzles on the bottom door. The elevation difference of these three nozzles is what sets my crateless retort apart from the traditional crateless retort. Drain nozzle is at the lowest elevation. Water inlet nozzle is at the middle elevation. Finally, the steam nozzle is at the highest of the three elevations. This simple equation, X≦y≦Z, demonstrates the fact that any water entering the retort will rise in level and ultimately mix with the steam to automatically create an unstable condition. The lower temperature water would never reach the cans in the bottom of the retort without this unstable condition occurring. This unstable condition will prevent under processing because the cook would be terminated, and product quarantined inside the retort.

### BACKGROUND

In the summer of 2007, a multi-million dollar recall was forced upon a manufacturer of low acid canned food products (the state of Georgia). The recall was a result of botulism consumption by four people in two states (Texas and Indiana). An investigation headed by the FDA was conducted at the plant to determine the cause of the botulism. I was asked to be part of that investigation.

The results of the investigation concluded that water entered one of the crateless retorts during a thermal process. As a result, some cans were subject to water, thus preventing some of the cans from reaching the sterilization temperature. Conditions inside some of the cans were such, that along with those same cans not reaching the sterilization temperature, a circumstance was created allowing the formation of botulism toxin.

These cans were distributed across the country, and eventually consumed by some customers. People were hospitalized, but there were no fatalities.

### SUMMARY

Crateless retorts are desirable in canning plants because they can mass produce cans for a variety of foods including vegetables, soups, stews, etc. The crateless retort's appeal is that they reduce labor costs by batch producing and minimizing material handling. One major difference in crateless retorts over other conventional retorts is that the steam injection (for cooking and sterilization) is through a “spreader” from the top of the retort and is vented at the bottom. Some “classic” vertical retorts inject steam at the bottom and vent through the top.

Although the design of the crateless retorts is very attractive, there are also dangers associated with it because of concealed, or less noticeable potential causes for under processing. Under processed canned food is potentially fatal if consumed. Manufacturing product recalls are a reality with conventional crateless retorts due to possible under processing.

### DEFINITIONS AND DRAWINGS

Retort—A vessel made of steel that uses a saturated steam condition under constant pressure and temperature to cook and sterilize canned foods.
Vent—The portion of the cooking process in which steam enters the retort at high volumes to remove any air and water from inside the retort so a saturated condition of steam exists inside the retort.
Cushion Water—160 degree F. water that is used by filling the retort with the water before cans are loaded into the retort to let the cans “drift” to the lowest point.
Cooling Water—160 degree F. water that is used by filling the retort with the water after the thermal processing of the cans. This water begins the cooling of the 250 degree F. cans and aids in the “Vacuum Dump” portion of the process.
Cook—The retort process in which the temperature and pressure inside the retort are at a prescribed constant set point, for a prescribed period of time.
Collapsed Steam—Water, or condensate, generated from steam changing phase to water.
Steam Spreader—A pipe inside a retort that has holes in it to allow steam to enter the retort.
Cooling Canal—Section of the crateless system that contains water at a temperature that will allow cans to cool from their cook temperature, to a temperature which will allow for human handling.
Vent Hole—A small opening in the retort that is at the opposite end of the steam spreader.
Bleeder—A small drain line that removes any moisture inside a retort during a cook. The bleeders are to be checked routinely by the operator during a cook to see if any water is in the retort at an undesirable time.
Traditional Vertical Retorts—Retorts that have steam spreaders at the bottom, and a vent hole at the top.
Vacuum Dump—The part of the process in which the cans drift out of the retort through the bottom of the retort. At this time, the retort is full of water, and there is no air allowed to enter the retort. Once the bottom door is opened (the bottom door of the retort is below the water level of the cooling canal), the water inside the retort remains inside.

### DRAWINGS

Note: Drawings are not to scale.

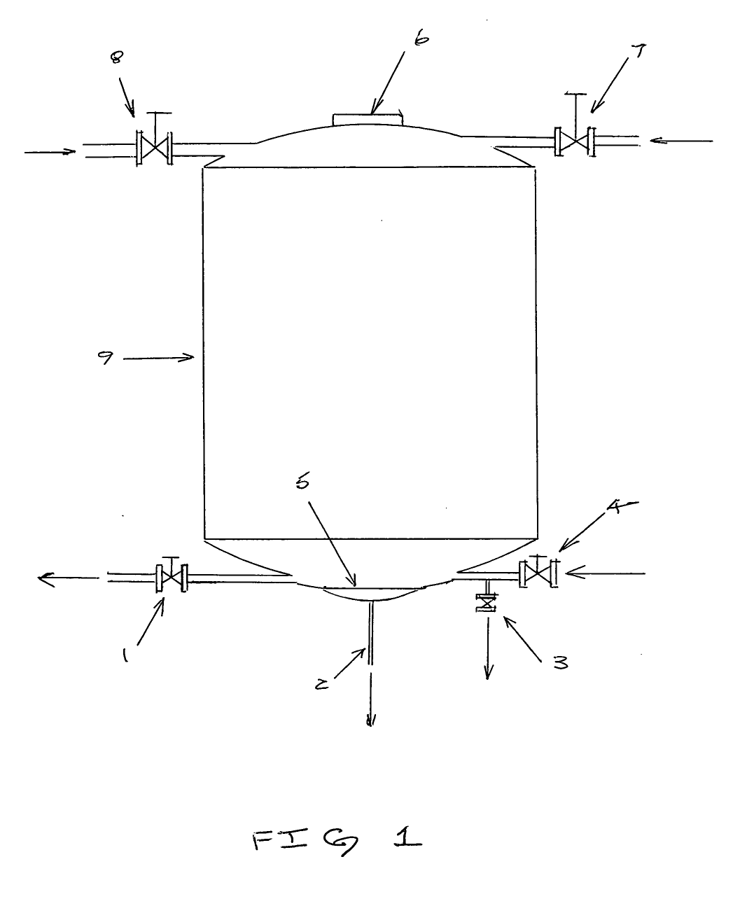

FIG. 1—Schematic of the traditional crateless retort where number designations are as follows:
Item 1—Air operated drain valve
Item 2—¾″ bleeder line
Item 3—Bleed valve for any water that leaks past valve #4 when #4 is in the closed position
Item 4—Air operated hot water valve
Item 5—Seal of the bottom door and the bottom of the retort. This is where the lowest cans in the retort are located while the retort is in “cook”
Item 6—This is the top door where preprocessed cans enter the retort (shown in the closed position)
Item 7—Air actuated steam control valve
Item 8—Air operated hot water inlet valve (preprocessed cushion water)

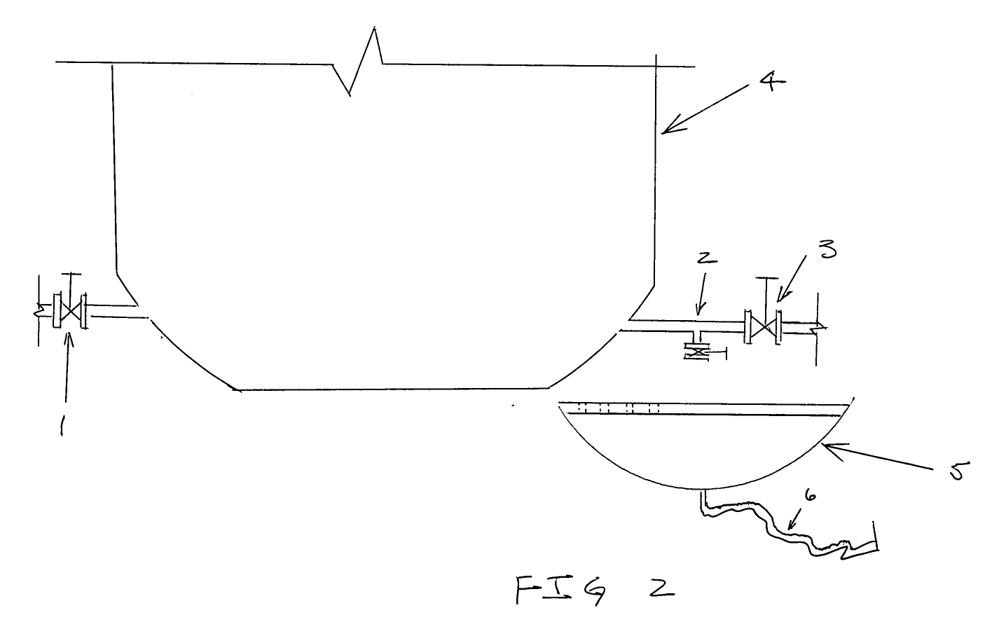

FIG. 2—Sketch of the bottom door in the open position of the crateless retort where number designations are as follows:
Item 1—Air operated drain valve
Item 2—Tee with air operated bleed valve (same valve item 3, on FIG. 1). This valve is supposed to let any water that leaks past the cooling water valve (item 3 on FIG. 2) drain out of this pipe and into the canal so cooling water does not enter the retort during the cook. This device was proven to be one of the causes of the botulism in the investigation headed by the FDA in the summer of 2007.
Item 3—Air operated cooling water valve. This valve is to remain closed during the cook so water does not enter the retort and causes under processing.
Item 4—Retort shell.
Item 5—Bottom door in the open position. The door has ¾″ diameter holes in the top of it to allow condensate to be removed during the cook.
Item 6—¾″ flexible stainless steel hose. This line removes the condensate collected through the holes in the bottom door to remove condensate to drain.

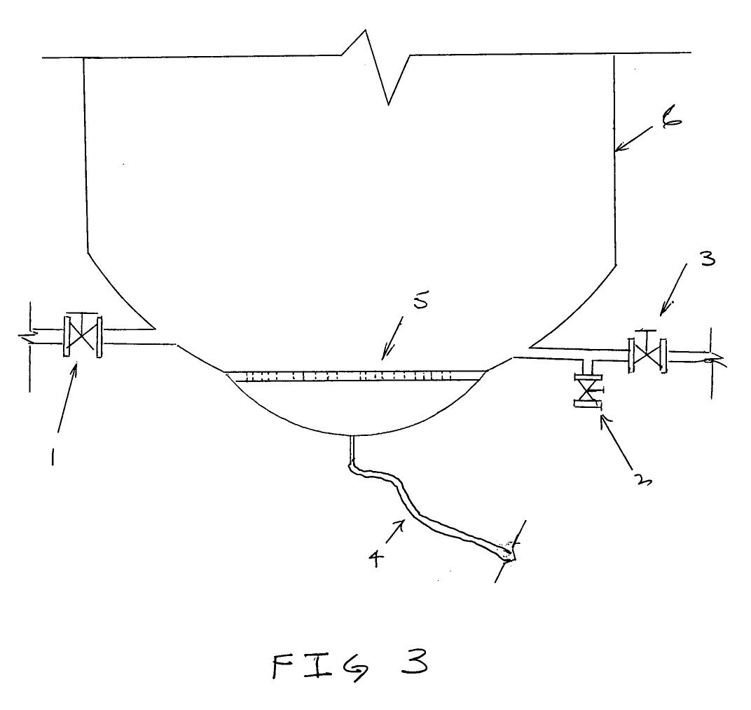

FIG. 3—Sketch of the bottom door in the closed position of the crateless retort where number designations are as follows:
Item 1—Air operated drain valve
Item 2—Tee with air operated bleed valve. This valve is supposed to allow any water that leaks past the cooling water valve (item 3 in this Fig) drain out of this line and into the canal so cooling water does not enter the retort during the cook.
Item 3—Air operated cooling water valve. This valve remains closed during the cook process and only opened after the cook process.
Item 4—¾″ stainless steel, flexible bleeder line
Item 5—Bottom door in the closed position. The door has ¾″ diameter holes in the top of it to allow condensate to be removed during the cook. The holes are shown as dashed lines in the door.
Item 6—Retort shell

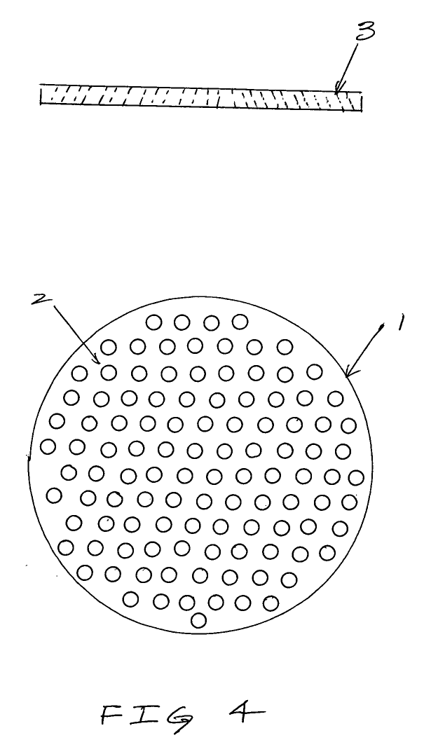

FIG. 4—Plan view sketch and a section view of my bottom door proposal. The holes in the door are at an “angle”. This allows the water and condensate to be able to drain out, and at the same time, assists the steam into a vortex during the cook.
Item 1—Bottom door plan view from inside the retort.
Item 2—Shows a series of ¾″ holes to allow condensate to be removed and allows the steam enter the retort from the bottom.
Item 3—Sectional view of the bottom door with the holes angled to allow for a steam vortex up through the retort.

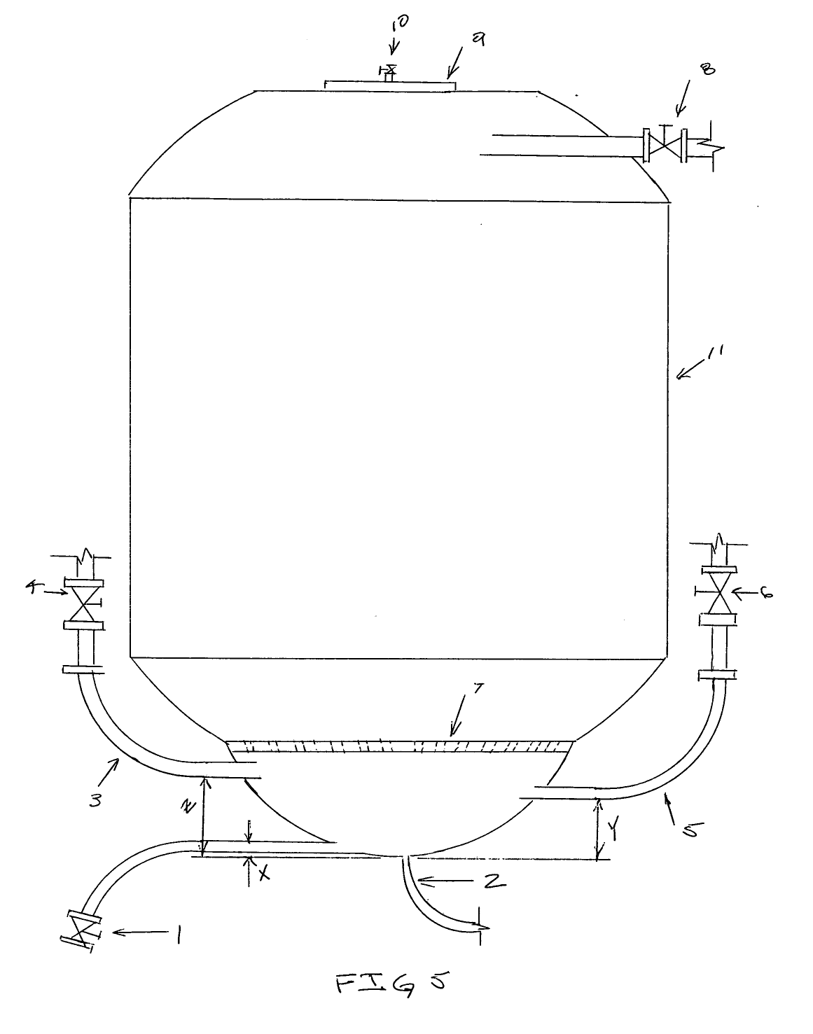

FIG. 5—Sketch of my proposed crateless retort. The pipes that are attached to the bottom door, item 7 (steam, water, drain, and bleeder) are braided stainless or other flexible material that can withstand 250 plus degree F. temperatures so they can “flex” when the bottom door opens. The drawing shows the valves located close to the door for simplification of the claim. The three nozzles on the door can be located any where on the door so all of the hoses flex in the same direction. Descriptions of components are described below. Notice the difference in dimensions of the elevations of the piping on the dome under the bottom door. The condensate line is at the lowest portion of the dome. The drain line (item 1) is just above the condensate line. The cooling water line and valve (item 4 and 5 is also the same inlet for cushion water inlet) is just above the drain valve and line (item 1). And finally, the steam for the inlet for the cook cycle is the highest pipe in the dome of the bottom door (item 3).
Item 1—Drain valve attached to flexible hose. Drain empties into a holding tank to be reused for cooling water and/or cushion water.
Item 2—¾″ condensate removal flex hose. Condensate removal hose goes to sewer drain.
Item 3—Flex hose for the steam inlet for the cook cycle.
Item 4—Steam inlet valve for the cook process only.
Item 5—Flexible braided hose for cooling water inlet.
Item 6—Air operated valve for cooling water and cushion water.
Item 7—Bottom door with the ¾″ perforated holes. Holes allow retort to drain of water and condensate, and allows the steam during a cook to cook the cans.
Item 8—Air operated steam inlet valve for blow down of cushion water and vent only.
Item 9—Top door, when opened, allows pre-processed cans to enter the retort and closes before the cook. When it is closed, it seals and allows steam pressure to build to the set point and remains sealed until the vacuum dump begins.
Item 10—⅜″ air operated control valve is open during the cook cycle only.
Item 11—Retort shell.

### THE BASIC CRATELESS RETORT DESIGN

Crateless retorts use a design that requires the following steps (potential under processing of canned foods are a proven reality with this type of retort). See FIG. 1.
1. The bottom door is closed, sealed, and the top door is open.
2. The retort is filled with hot cushion water (item 8, FIG. 1). The water is “hot” because it needs to be at a prescribed temperature in order for the initial temperature (IT) of the first can to enter. If it is not “hot” water, the cans are subjected to a low temperature prior to sterilization by the cook process. Low initial temperatures may affect the sterilization of the cans because they are not exposed the correct amount of steam for the correct amount of time and temperature.
3. Once the retort is full of hot water, pre-cooked cans are sent in to the retort through the top door (item 6, FIG. 1), drop into the water inside the retort, and slowly drift to the bottom. They nest at the bottom where they land (no organization to them).
4. Once the desired amount of cans have entered the retort, the top door is closed (item 6, FIG. 1) and sealed (with hydraulic locking cylinders).
5. The drain valve (Item 1, FIG. 1) on the bottom of the retort door (Item 5, FIG. 1) opens.
6. The steam is turned on. The steam enters the retort through a “spreader” at the top of the retort, above the highest can (Item 7, FIG. 1).
7. The steam forces the water out through the drain valve (item 1, FIG. 1) and the temperature inside the retort rises. The “vent” process then begins.
8. Once the preset temperature is reached for a preset period of time, the drain valve closes (Item 1, FIG. 1) and the “cook” begins.
9. While cooking, the vent at the bottom (¾″ braided stainless hose, item 2 FIG. 1) of the retort allows all of the condensate from the collapsed steam to escape. If the condensate does not exit the retort, the condensate level could increase and reach the cans at the bottom. If this happens, the cans would never reach the sterilization temperature, and cause under processing (potential botulism). As everyone knows, water boils at 212 degrees Fahrenheit. The cook temperatures inside a retort are well above 212 degrees.
10. After the cook is completed, the steam valve is closed (Item 7, FIG. 1), and the retort opens the cooling water valve, (Item 4, FIG. 1, again using “hot” water). The cooling water inlet to the retort is located at the bottom of the retort. Filling the retort with hot cooling water serves two purposes. First, it allows the cans to “cool” from the cook temperature prior to being dropped into the cooling canal below the retort. The second purpose is that once the level of cooling water reaches the top of the retort, the bottom door is opened (this door is below the top water level of the cooling canal). This creates a vacuum inside the retort. The cans then slowly sink out of the retort into the canal, causing no damage to the cans.
11. Conveyors then remove the “cooked” cans out of the canal.
   This crateless retorting system is a very efficient design as it minimizes labor for handling the cans and mass cooks the canned product. However, the design is not perfect and it allows the cans inside the retort to be prone to under processing by water leaking through the cooling water valve (Item 4, FIG. 1). Below are the design characteristics of the crateless retort.
12. The retort has a bottom door that holds the cans above the condensate collection area. See FIG. 1 and FIG. 3. The door has holes in it to allow the condensate to drain out the bottom of the retort (government requirements state that the vent has to be on the opposite end of the steam inlet of any retort). The steam inlet on the crateless retort is on the top, thus vents at the bottom.
13. The cushion water inlet (pre processing for allowing the cans to “drift” to the bottom) is at the top of the retort. See item 8, FIG. 1.
14. The cooling water inlet (for post processing cooling and vacuum dumping of the retort) is at the bottom of the retort, but above the bottom door. See FIG. 1 and FIG. 3.
15. This cooling water inlet (is at the bottom of the retort, and above the bottom door). The design of the crateless retort is such that there are valves on the cooling water inlet designed to prevent any water that might get past the air operated butterfly valve to go through the bleed valve that is located on the up stream side of the air operated butterfly valve. See item 2 and 3, FIG. 3.
16. If these valves fail, and based on the FDA investigation they can, water can enter the bottom of the retort (again, I stress that water enters above the lowest can in the retort).
17. If this water “leaks” into the retort, it can trickle over some of the lower cans inside the retort. If this happens (and I proved that it can), then cans would be subject to the under processing that can cause botulism (if the bacteria is already present in the can and the conditions are right).
18. The water then drains through the holes in the bottom door and exits the retort as condensate. Yet no one would know that there are cans subject to this water, or the subject to potential under processing.
   Note: The cooling water bleed line shown in FIG. 3 as item 2, is open during the cook process which allows any water that may leak through the cooling water valve (FIG. 3, item 3) drain out of the water line rather than entering the retort during the cook cycle.
19. Once the cook cycle is complete, the retort is filled with hot. This time water enters from the bottom. See item 4 FIG. 1, or item 3, FIG. 3.
20. Once the retort is full of cooling water, a vacuum is established inside the retort because all valves and openings are closed. The bottom door (which is above the water line in the cooling canal) is opened. This creates the “vacuum dump” which allows the cans to slowly drift, harmlessly out of the retort and into the canal.
21. The potential under processed cans enter the canal like the correctly processed cans. Due to the fact that it is a batch dump into the cooling canal (10,000 cans at a time) and the fact that the cans are not organized by canning codes, the success rate of predicting when cans were actually processed at sterilization temperatures (if there are water leaking problems) is impractical and unrealistic.
   Note: This probability has been documented in an FDA investigative report in the summer of 2007 in a low acid canning plants crateless retorting system as a result of a recall for botulism toxin.

### Available Equipment Upgrades Available on the Market:

a. Upgrades to prevent the results of problems listed above are available for the owners of crateless retorts and users of crateless retorting systems. These upgrades include “double block and bleed lines” on the cushion water, cooling water and compressed air lines to try to minimize the risk.
b. These upgrades also include conductivity probes in the water bleed lines to detect any moisture that might get into the retort and cause under process cans.
c. The computer system that monitors the moisture (water) that might enter the retort during cooking is state of the art. It is accompanied by many warning signs and computer password protections. This is an attempt to eliminate a possible problem by informing the operator that water might be in the retort at an undesirable time.
d. These alarms are only as good as the system allows. By that I mean if there is a problem with water leaking past a valve, these alarms are intended to notify operators of the retorts that there is a problem, but it does not fix the problem.
e. The alarm mechanisms can fail, and will, eventually fail.

### Proposed Invention:

1. There would be two steam lines entering the retort. One would be at the top for blow down and vent (item 8, FIG. 5) and the other on the bottom door (item 3 and 4, FIG. 5). The top steam line, when opened, is to remove the cushion water quickly out the drain valve (item 1, FIG. 5) at the bottom of the retort. The lower steam line would be located below the bottom door, but above all water inlet lines. (This point is critical to the success of the retort). This steam line would be used for venting, and cooking, not blow down of the cushion water.
2. Before the unprocessed cans enter the retort, the hot water would enter the retort from the bottom, below the bottom door, and below the bottom steam spreader. See bottom door configuration of item 5 and 6, on FIG. 5.
3. Once the water level reaches the upper water probe, the unprocessed cans enter the top of the retort, and float to the bottom as traditional crateless retorts.
4. Once the retort is full of cans, the top door is closed (item 9, FIG. 5), the drain valve opens (item 1, FIG. 5), and the steam inlet at the top of the retort opens (item 8, FIG. 5).
5. This allows all of the water to drain out of the retort and into a holding tank, sump, sewer, or whatever the user desires.
6. Once the level probe in the bottom of the retort no longer recognizes water in the retort, the drain valve closes (item 1, FIG. 5) and the top steam valve closes (item 8, FIG. 5).
7. Now, the vent at the top of the retort (in the middle of the top door) opens (item 10, FIG. 5), and the bottom steam valve opens (item 4, FIG. 5). This begins the vent cycle. The vent cycle allows the retort to remove all air and creates a saturated steam environment like any traditional vertical retort. The vent continues until a preset time and temperature is met by the designated process authority.
   Note: The uniqueness of this design is that the bottom steam inlet line is above all other water inlet lines in the bottom of the retort. (This concept is the vital point of my crateless design). See FIG. 5. If any water enters the retort through a leaking valve, then the water that is leaking in through the bottom of the retort would have to rise in level (assuming the bleeders are unable to remove the water as quickly as it enters). If the bleeder (item 2, FIG. 5) is unable to remove the excess water, then the water level rises, and eventually reaches the steam inlet (item 3, FIG. 5). This concept will prevent under processing. If the water level reaches the steam inlet level, (water level is still below the lowest can), the 250 degree steam would mix with the water entering the retort. This creates a significant pressure and temperature change in the retort. This change would be great enough that the steam pressure and temperature controls would not be able to respond quickly enough. This would cause a volatile, unstable process, and the cook would be considered void by any operator, and the retort would no longer be usable until the cause of the instability is found. With the traditional crateless retort, any water entering the retort would not come into contact with the steam spreader (traditional crateless retorts has the steam spreader at the top of the retort) and not create an unstable condition. These unstable conditions are what trigger an abnormal pressure and temperature that is recorded on the chart recorder. The retort will have enough instability in pressure and temperature because of instantaneous collapse of steam by contacting the water leaking past a valve (if the water reaches the bottom steam spreader). This would immediately notify the operator, maintenance, or quality control, and the processing authority would recognize an under processed condition, and the cook would never be allowed to continue.

1. The simplest explanation of the claim is summarized on FIG. 5. The elevation dimensions of the inlet and outlet nozzles on the bottom door are such that the steam inlet is the highest elevation. The hot water inlet is the middle elevation, and the drain line is the lowest elevation, or as FIG. 5 indicates, X≦Y≦Z. This is the claim on the crateless retort system I am describing. This configuration allows the cook process to “detect” or “warn” an operator of an unstable condition automatically. If water enters through the water valve, the water would have to reach the steam inlet nozzle before the water would reach the cans in the lower section of the retort (immediately above the bottom door).
The ¾″ bleeder line is located just below the drain line. This bleed line serves as an indicator to the operator of the retort that there is water entering the retort. If water enters the retort fast enough, it will rise in elevation if the bleeder cannot remove the water as quickly as the water is entering If water does enter faster than the bleeder can remove it, the water would eventually reach the steam spreader. If this happens, the cook would become unstable because of the volatility of 160 degree water reaching 250 degree steam. The control system will not handle the mixture of the varying temperatures, the temperature and pressure fluctuations would be recorded on the chart recorder, the cook would fail, and the product would have to be reprocessed or destroyed.
Note: The conventional crateless retort has the steam spreader at the top of the retort. If water does enter at the bottom of a conventional crateless retort, the water would never reach the steam spreader and cause the volatile reaction which would notify the operator or QC personnel.
The types of piping required to make the steam, water, and drain lines practical on the bottom door can be done in several ways.
All of the lines supplying the steam, water, and drain lines can be flexible stainless braided hose or some other flexible material that could be used on hot water and 250 degree steam.
The spacing between each retort could be such that the steam, water, and drain lines can be physically separated when the bottom door needs to be opened, and the pipes mechanically reattached after the bottom door is closed.
Telescoping pipes can also be used, much like air or hydraulic cylinders.
In addition to the above three bullets, there are other means that can make the water lines, steam line, and drain lines acceptable.

2. The angled holes in the bottom door allow for both, the removal of water to drain (for cushion water and condensate) and allow the steam to generate a vortex affect which helps with steam, or heat distribution during a cook cycle.
